(19) United States
(12) Patent Application Publication
(10) Pub. No.: US 2016/0070881 A1
(43) Pub. Date: Mar. 10, 2016

(54) SYSTEM, METHOD AND GRAPHICAL USER INTERFACE FOR CREATING MODULAR, PATIENT TRANSPORTABLE GENOMIC ANALYTIC DATA

(71) Applicant: Admera Health LLC, South Plainfield, NJ (US)

(72) Inventors: Hansel Brady Millican, III, Lakeland, FL (US); Guanghui Hu, Westfield, NJ (US); Wing-Sheung Lee, East Brunswick, NJ (US); Min Wei, Long Valley, NJ (US)

(21) Appl. No.: 14/844,155

(22) Filed: Sep. 3, 2015

Related U.S. Application Data
(60) Provisional application No. 62/046,516, filed on Sep. 5, 2014.

(51) Int. Cl. G06F 19/00

(52) U.S. Cl. CPC G06F 19/3456; G06F 19/366; G06F 19/326; G06F 19/322

(57) ABSTRACT

Systems and methods may be provided for the generation, online viewing and display of the level of significance, and printing of reports created by the analysis and diagnosis of DNA, mRNA, protein derived from blood, urine, stool, tissue and organ specimens provided to clinical laboratories by client/physicians. These reports graphically and tabularly indicate the severity, diagnosis and prognosis of the specimen and include visual analysis, textual analysis, prognostic and treatment information. Systems and methods are also provided for the generation, online viewing and printing of prognostic fact sheets that are related to other disease states based on the genetic testing results of a specimen, and for the generation, online viewing and printing of comprehensive patient genotype result and drug recommendation by specialty.

### CROSS-REFERENCE TO RELATED APPLICATION

This application claims the benefit of U.S. Provisional Application No. 62/046,516, filed on Sep. 5, 2014, entitled, SYSTEM AND METHOD FOR CREATING MODULAR, PATIENT TRANSPORTABLE AND ONLINE VIEWING OF GENOMIC ANALYTIC REPORTS, which is incorporated by reference herein in its entirety.

### FIELD

The present application relates generally to computers, computer applications, information processing, modular clinical testing reports, and particularly to creating reports through system interfaces and bioinformatics algorithms that facilitate understanding of genetic test results and the transportability to different specialties, and providing online views of the reports.

### BACKGROUND

With the advent of the human genome, comprised of approximately 3.3 billion base pairs, being fully mapped by 2004, the medical clinical and research community has just started taking advantage of genetic information to better diagnose, treat and monitor patients. The first example of the benefits of genetic testing was in breast cancer, with the use of Herceptin based on Her2neu results. Now, instead of one genetic mutation being tested for there are platforms that can do multiple genetic testing. The raw data associated with this testing is orders of magnitude larger and synthesizing the information is not a simple task.

### BRIEF SUMMARY

A computer-implemented method and system for creating modular, patient transportable genomic analytic data, and a user interface thereof, may be provided. The method, in one aspect, may include receiving sample data entered into a laboratory information system. The method may also include performing de-identification of the sample data and generating a unique identifier (ID) per sample. The method may further include producing next generation sequencing data per sample. The method may also include generating, by a computer server, variants and coverage data associated with the sample having the unique ID. The method may also include performing, by the computer server, genotype, phenotype data analysis based on the variants and coverage data. The method may further include providing, by the computer server, clinical interpretation for drug usage and dosing recommendation associated with the unique ID. The method may also include generating, by the computer server, a report based on the clinical interpretation for drug usage and dosing recommendation associated with the unique ID.

A system for creating modular, patient transportable genomic analytic data, in one aspect, may include one or more hardware processors. The system may also include a laboratory information system operable to receive sample data and perform de-identification of the sample data and generating a unique identifier (ID) per sample. The system may also include a computer server comprising bioinformatics data analysis pipeline operable to generate variants and coverage data associated with the sample data having the unique ID, the computer server operable to execute on one or more of the hardware processors. The computer server may be further operable to perform genotype, phenotype data analysis based on the variants and coverage data and provide clinical interpretation for drug usage and dosing recommendation associated with the unique ID. A report generation module may be operable to execute on one or more of the hardware processors and further operable to generate a report based on the clinical interpretation for drug usage and dosing recommendation associated with the unique ID.

A user interface that provides modular, patient transportable genomic analytic data may include a plurality of sections that provide, for example, visit snapshot according to ICD codes, e.g., in section 1 and 2; Summary of current medications, e.g., in section 3; Patient Portable, e.g., in section 4; All interactions (DDI, Food to Drug, Alcohol to Drug and Laboratory), e.g., in section 5; and Patient gene summary (Genotype and Phenotype) table, e.g., in section 6. Information may be culled to populate the sections in the IP.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is an illustrative overview of an exemplary system to generate a report on a specimen and view the report online, in accordance with an embodiment of the present disclosure.

FIG. 2 illustrates bioinformatics quality control (QC) process in one embodiment of the present disclosure.

FIG. 3 illustrates a schematic of an example computer or processing system that may implement a system in one embodiment of the present disclosure.

FIG. 4 is another example of a system diagram illustrating components of the present disclosure in one embodiment.

FIG. 5 shows a process flow of a bioinformatics pipeline performed on a computer server, in one embodiment of the present disclosure.

FIGS. 6-10 show example reports in one embodiment of the present disclosure.

### DETAILED DESCRIPTION

A methodology of the present disclosure in one embodiment synthesizes all the actionable data from multiple sources and places it in a portable clear and concise format that can be understood by not only the physician but by the lay patient as well. The construct of the report is unique in multiple ways. In one embodiment, a methodology of the present disclosure creates sample sequencing raw data from laboratory information management system (“LIMS”). Briefly, LIMS is a laboratory informatics system, and provides capabilities such as sample management, assay data management, data analytics and electronic laboratory notebook integration. LIMS may also feed control files into a laboratory instrument and direct its operation on a physical sample, e.g., in a tube or plate.

The present disclosure also discloses device interoperability and information processing workflow. For example, LIMS may be interfaced with laboratory information system (“LIS”) for interoperability. LIS is used to store patient medical information and generate clinical interpretation report and LIMS manages laboratory's operation workflow and supports data tracking.

As will be appreciated by one skilled in the art, the present invention may be embodied as a method, a data processing system, or a computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the storage medium. More particularly, the present invention may take the form of web-implemented computer software (SAAS). Any suitable computer-readable storage medium may be utilized including hard disks, CD-ROMs, optical storage devices, or magnetic storage devices.

These computer program instructions may also be stored in a computer-readable memory that can direct a computer or other programmable data processing apparatus to function in a particular manner, such that the instructions stored in the computer-readable memory produce an article of manufacture including instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

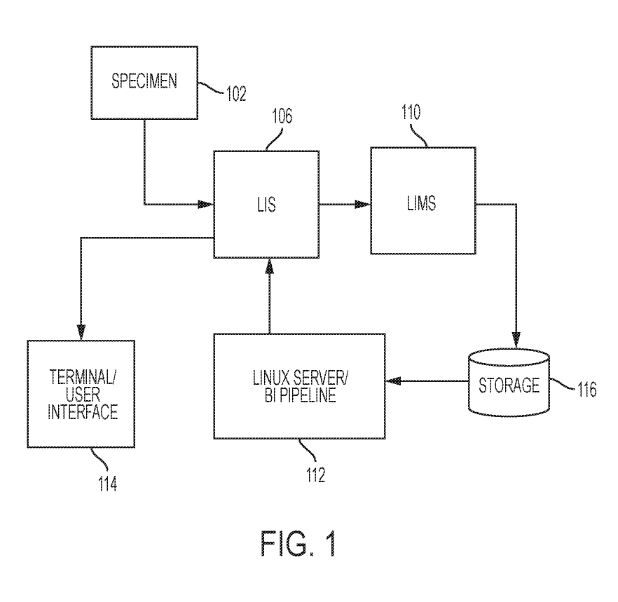

FIG. 1 is an illustrative overview of an example system to generate a report on a specimen and view the report online, in accordance with an embodiment of the present disclosure. The example system illustrated in FIG. 1 comprises a specimen 102 that is provided to laboratory for testing. A laboratory information system (“LIS”) 106 may be used by the physician office, hospital laboratory or remote specimen collection place or laboratory performing the testing, or the like, to enter information into the LIS 106 by methods which are known in the art. After the protected health information (“PHI”) data of the patient and the collected specimen 102 data are accessioned into LIS 106, the specimen 102 is de-identified and its unique identifier is pushed to LIMS 110 to start the assay specific workflow.

In LIMS 110, at the end of the assay specific workflow, the raw sequencing data (FASTQ files) of the specimen 102 is transferred to a secured data storage 116. A proprietary bioinformatics (BI) pipeline residing on a Linux server 112 fetches the raw data files from data storage 116 to perform primary data analysis which generates results that include but not limited to variant calling and copy number variation analysis. This BI pipeline also produces the clinical interpretations for the samples based on sample genotype and phenotype data.

The sample genotype and phenotype data and clinical interpretations generated from BI pipeline 112 are uploaded back into the LIS 106. Sample genetic and clinical information is re-identified with LIS 106 stored patient medical data to create a modular clinical report. This report is available for online viewing and can also be downloaded and sent as hardcopy. A terminal or computer 114 can be utilized to view the online results via a web browser and to print the online results, diagnostic fact sheets, reports, and requisitions via a printer. The LIMS 110, the LIS 106, and the terminal or computer 114 may be connected to one another through interfaces by a network such as Internet, Ethernet, telephone, a virtual private network, wireless, fiber optics, or by another method or combinations thereof. In another aspect, an LIS properly configured may perform the above functionalities. Hence, the methodology of the present disclosure is not limited to particular configuration shown in FIG. 1. Rather, one or more components may be configured to perform the disclosed functionalities.

The following description provides the inputs, outputs and functions of the components in one embodiment of the present disclosure.

Sample data may be entered into an LIS (e.g., 106). Input to the LIS may include:

a) PHI data (e.g., name, date of birth, age, gender, address, disease conditions, ICD codes, treatments, drugs in use, etc.). Briefly, ICD codes refer to International Classification of Diseases used to assign codes to patient diagnosis.

b) Sample information (sample barcode, date collected, date received, type of samples, number of samples, any sample related comments, etc.).

c) Test information (type of test, etc.).

d) Referring physician information (name, institution, address, etc.).

LIS 106 may perform sample accessioning (e.g., ensure that the sample information entered into LIS matches with the sample information received in lab). LIS 106 may also conduct sample de-identification (e.g., randomly generate a unique case ID for each sample). LIS 106 may output a unique case ID for each individual sample.

In one embodiment of the present disclosure, the sample is sequenced on an assay specific Next Generation Sequencing (NGS) platform and managed by LIMS 110 (e.g., Genologics LIMS). LIMS 110 may receive as input a unique case ID for each sample, for example, generated by the LIS 106. LIMS 110 may manage assay specific NGS workflow and perform data tracking. Examples of the NGS platform may include but are not limited to: MiSeq and NextSeq from Illumina™. The NGS workflow may include DNA extraction, library preparation, sequencing and various quality control (QC) checking steps. LIMS 110 may output results from primary data analysis, including FASTQ files, variants and coverage data. The generated data may be transferred to another server 112 with data storage 116 for Bioinformatics data analysis.

The primary analysis data (FASTQ files, variants and coverage data) output from LIMS in one embodiment is further analyzed on a server 112 (e.g., Linux server) by BI pipeline to generate genotype and phenotype data. A knowledge base of pharmacogenomics data was curated and annotated based on the information from Food and Drug Administration (FDA) drug labels and recommendations from Clinical Pharmacogenetics Implementation Consortium and Royal Dutch Pharmacogenetics Working Group. This knowledge base stores the genotype data, phenotype data, drug dosing recommendations and their relationships. By querying this knowledgebase, the clinical interpretations on drug usage and dosing recommendation are generated based on sample's genotype and phenotype. A separate customized list of drug recommendations is also generated based on patient's diagnostics and the current prescribed medications. This list of drug recommendations is a subset of the comprehensive list and tailored to patient's current medical conditions and treatments.

In one embodiment, clinical report is generated by LIS. Input to LIS for report generation may include: a) Genotype and phenotype data associated with a unique case identifier; b) Comprehensive and customized diagnostic specific drug recommendations associated with a unique case ID; c) Drug recommendations for the current medications patient is taking; d) Drug to drug, food to drug, alcohol to drug interactions; e) All relevant lab test results.

In one embodiment, LIS 106 in generating a report may perform the following functions: a) Identify the right patient using a unique case ID; b) List all patient health information; c) Describe all specimen information; d) List ordering physician information; e) Snapshot diagnostic specific drug recommendations; f) Summarize recommendations for patient's current medications; g) List interactions between drug and drug, food, alcohol; h) Generate panel comprehensive drug recommendations table; i) Generate patient genotype and phenotype table.

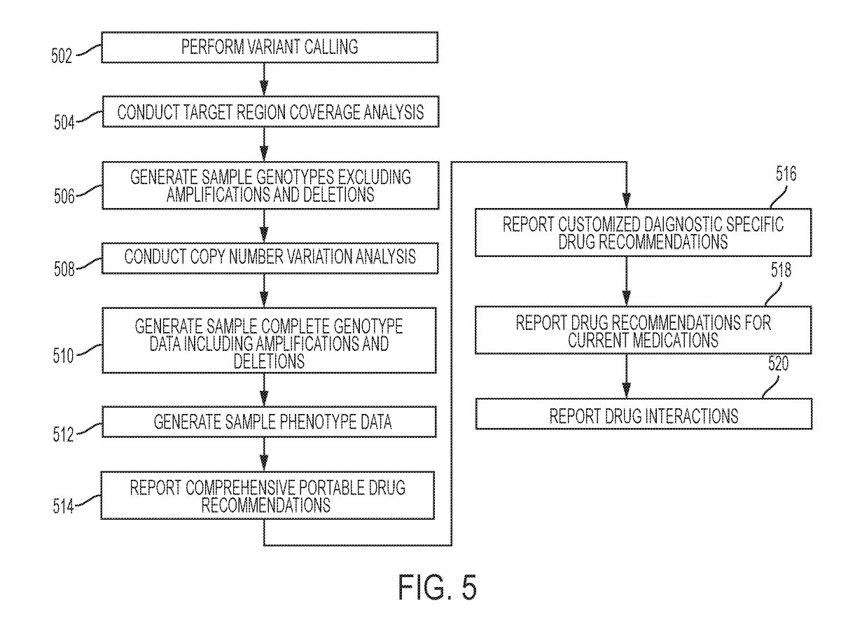

The following provides a technical description of the bioinformatics pipeline (e.g., the details of data analysis performed on a computer server (e.g., Linux server 112). FIG. 5 shows this process flow in one embodiment of the present disclosure:
1) Perform variant calling (at 502 in FIG. 5):
   Program: specialized NGS data analysis software (e.g., CLC Genomic Workbench).
   Input: FASTQ files (next generation sequence data with quality scores).
   Output: Variants with genomic locations and frequencies.
   In one embodiment, the processing at 502 may include the following work process: A bioinformatics program (e.g., the specialized NGS data analysis software CLC Genomic Workbench) maps the sequence reads (represented by FASTQ files including the quality scores for the individual reads) to the designated reference genome (e.g., human genome) and reports on positions where there may be a single nucleotide variation (SNV), insertion, deletion and substitution (variant calling) based on the sequence alignment between raw sequence reads and reference genome generated from the mapping process.
2) Conduct target region coverage analysis (at 504 in FIG. 5):
   Program: specialized NGS data analysis software (e.g., CLC Genomic Workbench).
   Input: FASTQ files (next generation sequence data with quality scores).
   Output: Genetic target region coverage represented by sequencing reads.
   In one embodiment, the processing at 504 may include the following work process: The specialized NGS data analysis software (e.g., CLC Genomic Workbench) maps the sequence reads (represented by FASTQ files including the quality scores for the individual reads) to the designated reference genome (e.g. human genome) and reports on the number of reads that matched to the selected regions of the reference sequence (target region coverage analysis).
3) Generate sample genotypes excluding amplifications and deletions (at 506 in FIG. 5):
   Program: programs based on the definitions for various alleles of panel genes, e.g., developed in Perl or the like computer programming language.
   Input: VCF files (variant calling results file from processing at 502).
   Output: Genotypes data not including amplifications and deletions.
   In one embodiment, the processing at 506 may include the following work process: The programs screen all the SNVs, insertions and deletions detected from Variant Calling step (represented as VCF files) and match them to the list of panel gene alleles, which shows all the genetic variations the panel covers and reports. Based on the matching results, all found genetic mutations are confirmed and listed out by gene symbols (genotype calling).
4) Conduct copy number variation analysis (at 508 in FIG. 5):
   Program: programs based on the fold change of average depth of coverage of a target gene between test sample and control sample, e.g., developed in Perl or the like computer programming language.
   Input: Target region reads (target region coverage analysis results file from step 2).
   Output: Gene deletion or amplification status.
   In one embodiment, the processing at 508 may include the following work process: For a particular gene with copy number changes detected in different populations and whose functional activities are affected by its gene copy numbers, a set of programs compare the number of sequence reads mapped to this gene between the test sample and control samples (Coverage Analysis results) and calculate the fold change to deduct the actual copy number for this particular of this test sample. Contrast to the normal gene copy number two, a deletion is called when the detected gene copy number is zero or one while an amplification is called when the detected gene copy number is greater than two (CNV analysis).
5) Generate sample complete genotype data including amplifications and deletions (at 510 in FIG. 5):
   Program: programs, e.g., developed in Perl or the like computer programming language.
   Input: preliminary genotype data (results from processing at 506) and gene copy number status (results from processing at 508).
   Output: Complete genotypes data including amplifications and deletions.
   In one embodiment, the processing at 510 may include the following work process: The initial genotype data generated from step 3 only includes SNVs, insertions and deletions. For a particular gene whose genotypes include copy number variations (deletions and amplifications), the CNV results from step 4 are incorporated into the initial genotype callings to complete the genotype call.
6) Generate sample phenotype data (at 512 in FIG. 5):
   Program: programs taking into consideration of two alleles of a particular gene and their corresponding enzymatic activity level, e.g., developed in Perl or the like computer programming language.
   Input: genotype data (results from processing at 510).
   Output: sample phenotype data.
   In one embodiment, the processing at 512 may include the following work process: The functional activity level of a particular gene is determined by the enzymatic functions of all its copies. Genetic variations could regulate gene's enzymatic functions in different directions (up or down) at various levels (trivial, some, significant). Based on the actual copy number of a gene and the specific genetic mutations on each copy, the overall functional activity level is calculated and categorized, for example ultra-rapid metabolizer, extensive metabolizer, intermediate metabolizer and poor metabolizer (phenotype calling).
7) Report comprehensive portable drug recommendations (at 514 in FIG. 5):
   Program: programs, e.g., developed in Perl or the like computer programming language.
   Input: Specific genotype and phenotype data of a patient (results from processing at 510 and 512).
   Output: A comprehensive portable drug recommendation list.
   In one embodiment, the processing at 514 may include the following work process: A proprietary pharmacogenomics knowledge base is built with clinical interpretations on genetic variations. The information is extracted from pharmacogenomics section of FDA (Food and Drug Administration) drug label and drug dosing information recommended by EMA (European Medicines Agency), CPIC (Clinical Pharmacogenetics Implementation Consortium) and DPWG (Dutch Pharmacogenetics Working Group) and is populated into the database. This knowledge base includes the detailed drug and dosing recommendations based on patient's genotype and phenotype, such as alternative drugs, dosing changes, cautionary steps and normal response. It also includes various supporting data, including but not limited to therapeutic areas, drug classes, clinical evidence, diagnostic codes and data resources. With a patient's specific genotype and phenotype information, a comprehensive portable drug recommendation list is generated based on the results queried out from the pharmacogenomics knowledge base.
8) Report customized diagnostic specific drug recommendations (at 516 in FIG. 5):
   Program: programs utilizing patient's diagnostic codes and current medications, e.g., developed in Perl or the like computer programming language.
   Input: comprehensive portable drug recommendation (results from step 7).
   Output: diagnostic specific drug recommendations.
   In one embodiment, the processing at 516 may include the following work process: From the comprehensive portable drug recommendation list generated at 514, a subset of recommendations on specific therapeutic areas and drug classes are selected based on patient's diagnostics and current prescribed medications.
9) Report drug recommendations for current medications (at 518 in FIG. 5):
   Program: programs utilizing current medications, e.g., developed in Perl or the like computer programming language.
   Input: customized diagnostic specific drug recommendations (results from processing at 516).
   Output: current medications recommendations.
   In one embodiment, the processing at 518 may include the following work process: Besides the specific drug recommendations provided for some of the current prescribed medications (results from 516), the rest of the drugs on the current medication list are covered in this section with weak clinical evidence or no available pharmacogenomics information.
10) Report drug interactions (at 520 in FIG. 5):
   Program: programs, e.g., developed in Perl or the like computer programming language, utilizing drug interaction data, e.g., which may be obtained from third party.
   Input: current medication list and drug interaction data.
   Output: drug, food, alcohol interactions for current medications.
   In one embodiment, the processing at 520 may include the following work process: For all drugs on the current medication list, drug and drug, drug and food, drug and alcohol interaction data is extracted from a licensed third party database.

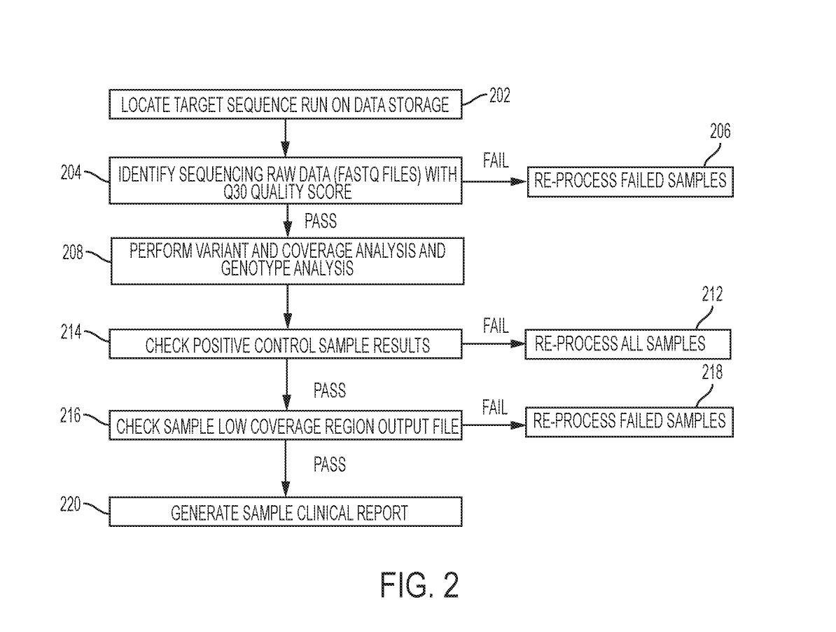

FIG. 2 illustrates bioinformatics quality control (QC) process in one embodiment of the present disclosure. The process shown in FIG. 2 in one embodiment may ensure high quality results in the bioinformatics process. In one embodiment, it works in the background, e.g., as a background process, as a safety net for filtering out low quality data. At 202, a target sequence run transferred to a designated data storage folder may be located. At 204, Sequencing raw data (FASTQ files) with Q30 quality score are identified, At 206, responsive to the QC at 204 failing, sample may be re-processed, e.g., second specimen from same patient is be processed. At 208, responsive to the QC at 204 passing, variant and coverage and genotype analysis may be performed. At 214, genotype results from positive control samples are verified. Responsive to the QC at 214 failing, all samples from this sequence run is re-processed at 212. At 216, responsive to the QC at 214 passing, sample low coverage regions may be checked. Responsive to the QC at 216 failing, any samples with low coverage on reported regions are re-processed at 218. Responsive to the QC at 216 passing, sample clinical report is generated at 220.

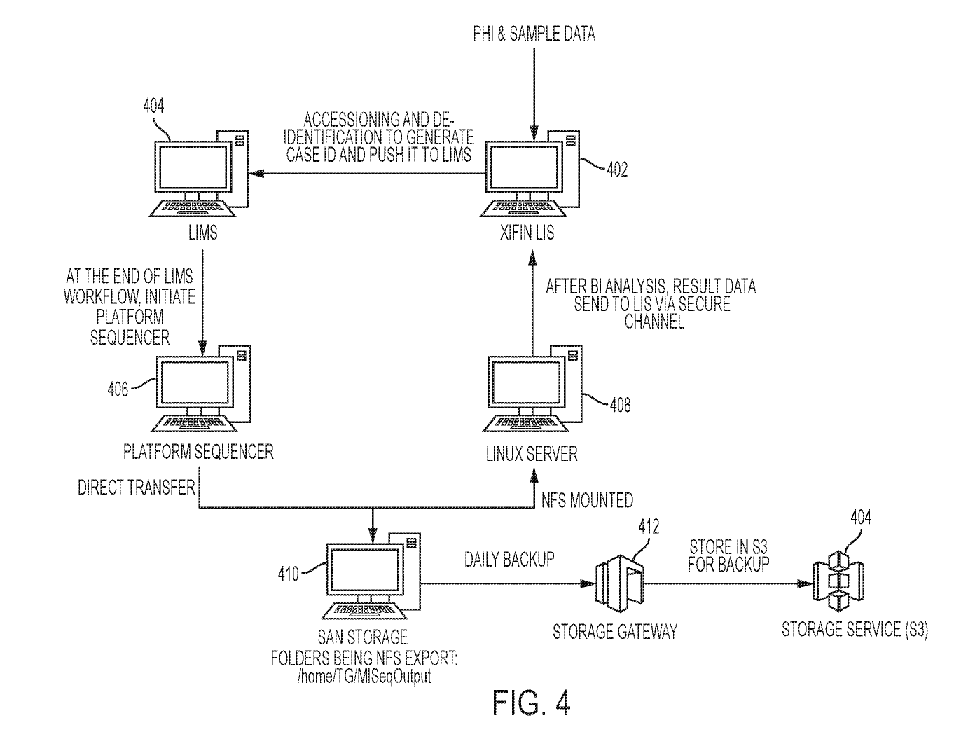

FIG. 4 is another example of a system diagram illustrating components of the present disclosure in one embodiment. It should be understood, however, the methodology is not limited to the specific components shown in FIG. 1. Rather, one or more components may perform the functionalities of the methodology disclosed here. For instance, LIS system 402 receives PHI and sample data, performs accessioning and de-identification to generate a unique case ID as described above with reference to 106 in FIG. 1. The unique case ID is pushed to an LIMS system 404. The LIMS system 404 performs pre-configured workflow as described above with reference to FIG. 1 at 110. At the end of workflow, LIMS system 404 triggers a sequencer (e.g., the Illumina Platform Sequencer) 406 to perform sequencing. The sequencer (e.g., Illumina Platform Sequencer) 406 stores its sequencing data directly to a storage area network (SAN) storage 410 into a designated folder, which may include a high-speed network of storage devices coupled with one or more storage servers. The sequencing data that is stored in SAN storage may be also stored at a backup storage, e.g., on a remote storage service 414 (e.g., cloud storage service). For example, the SAN storage data may perform a daily backup to the storage service 414 via a storage gateway 412. The backup in one embodiment may be performed periodically, or at every time interval. A computer server, e.g., LINUX server 408 performs its bioinformatics data analysis as described above with reference to FIG. 1 at 104. The server 408 transmits its data analysis output to the LIS 402 via a secure channel. The LIS 402 receives the output data from the server 408, e.g., comprehensive and customized diagnostic specific drug recommendation associated with a unique case identifier (ID) and gene average depth of coverage graph associated with a unique case ID, and generates a report based on the received data. For example, the reports are accessible via secure channel by physician or send to a printer.

A report that is generated according to an embodiment of the present disclosure includes may have a specific format showing information in different sections. For example, the report may be divided into sections such as: Visit snapshot according to ICD codes, e.g., in section 1 and 2; Summary of current medications, e.g., in section 3; Patient Portable, e.g., in section 4; All interactions (DDI, Food to Drug, Alcohol to Drug and Laboratory), e.g., in section 5; and Patient gene summary (Genotype and Phenotype) table, e.g., in section 6. Information may be culled to populate the sections in the IP.

A report, for example, may be provided via graphical user interface and displayed on a display device of a user computer. A report may also be saved or stored as an electronic document on a computer storage device and/or printed as a document via a printer device.

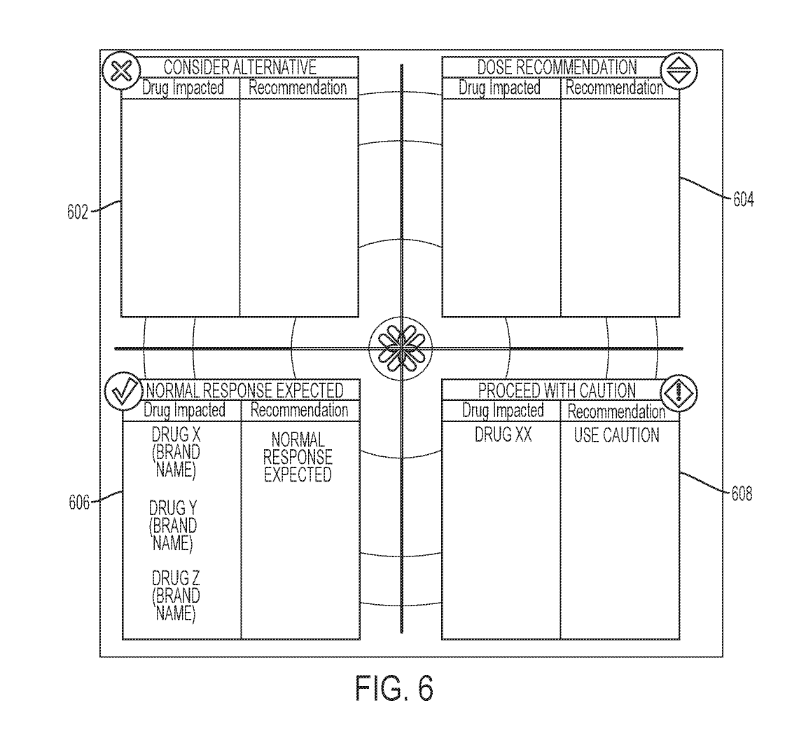

FIG. 6 shows an example report that may be presented, for example, via a graphical user interface on a display device in one embodiment of the present disclosure. The sample report shows a comprehensive drug information for a patient. For instance, different display panels may be shown for drugs of alternative consideration 602, drug dose recommendation 604, drugs expected to have normal responses 606, and drugs that the patient should proceed with caution 608.

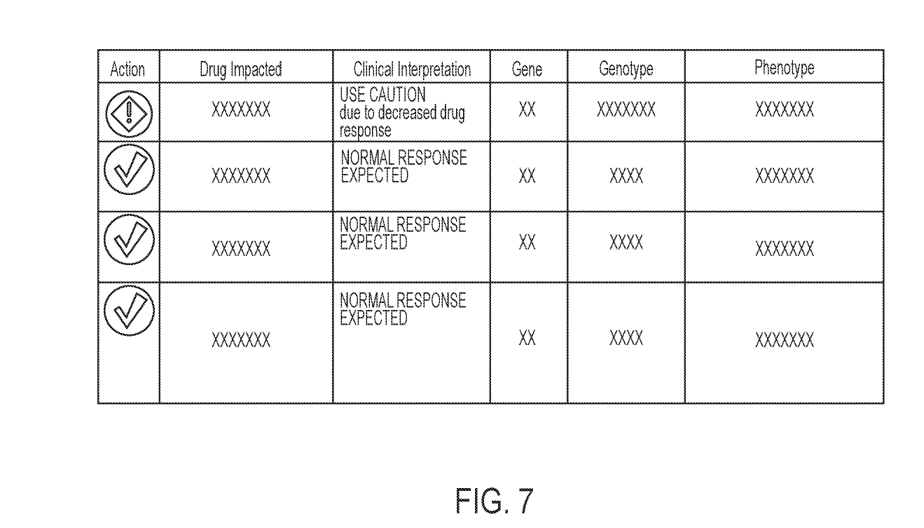

FIG. 7 shows another example report that may be presented, for example, via a graphical user interface on a display device in one embodiment of the present disclosure. The sample report shows patient specific genotype results and comprehensive drug information for a patient.

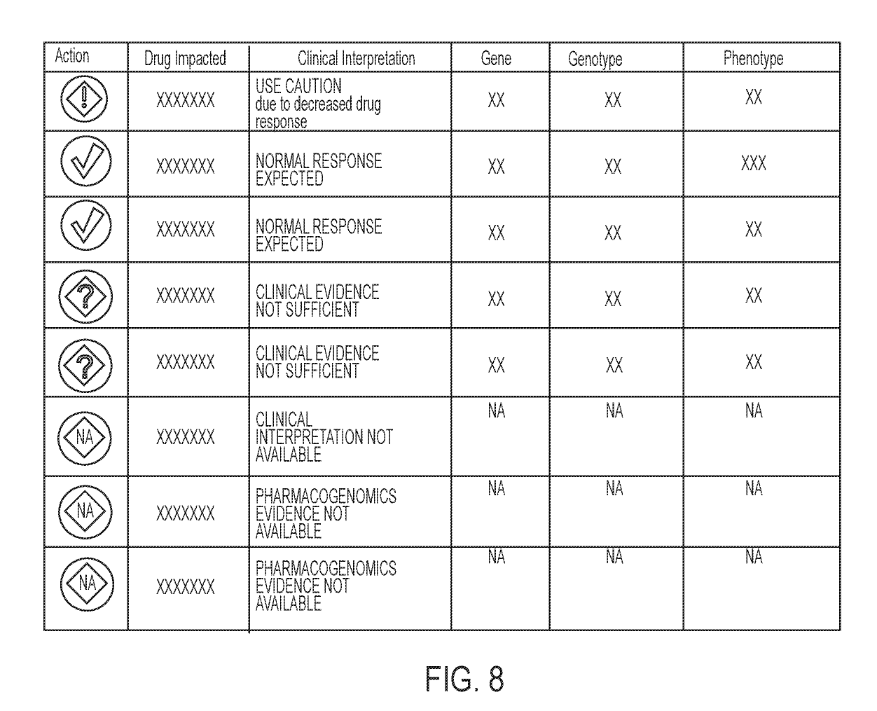

FIG. 8 shows another example report that may be presented, for example, via a graphical user interface on a display device in one embodiment of the present disclosure. The sample report shows current medication information for a patient. For example, for every current medication of a patient, information such as action, drug impacted, clinical interpretation, gene, genotype and phenotype may be shown in a tabular format.

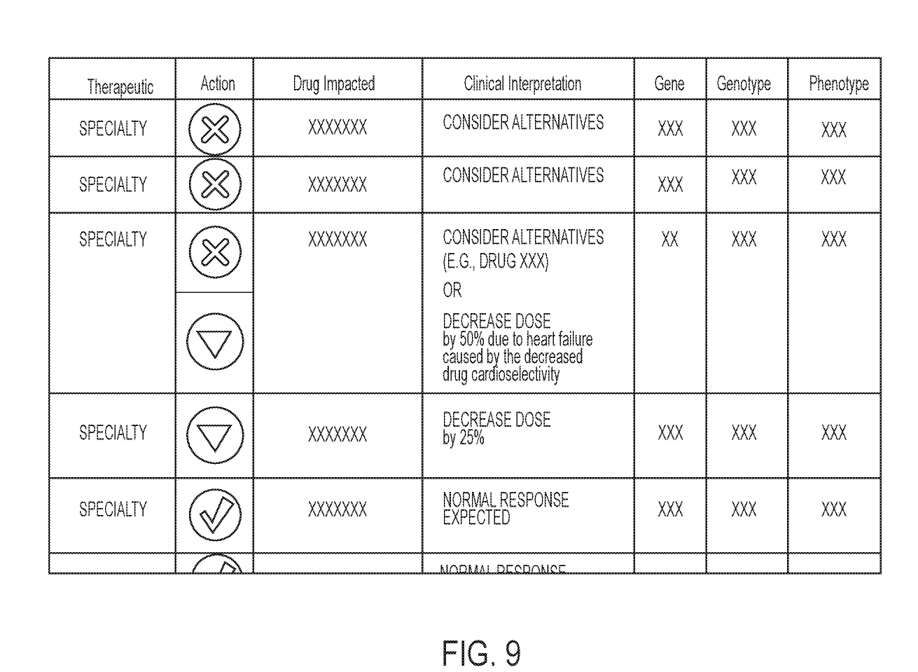

FIG. 9 shows another example report that may be presented, for example, via a graphical user interface on a display device in one embodiment of the present disclosure. The sample report shows genotype results and drug information by specialty for a patient. For example, the report shows in a tabular format therapeutic (specialty), action, drug impacted, clinical interpretation, gene, genotype and phenotype.

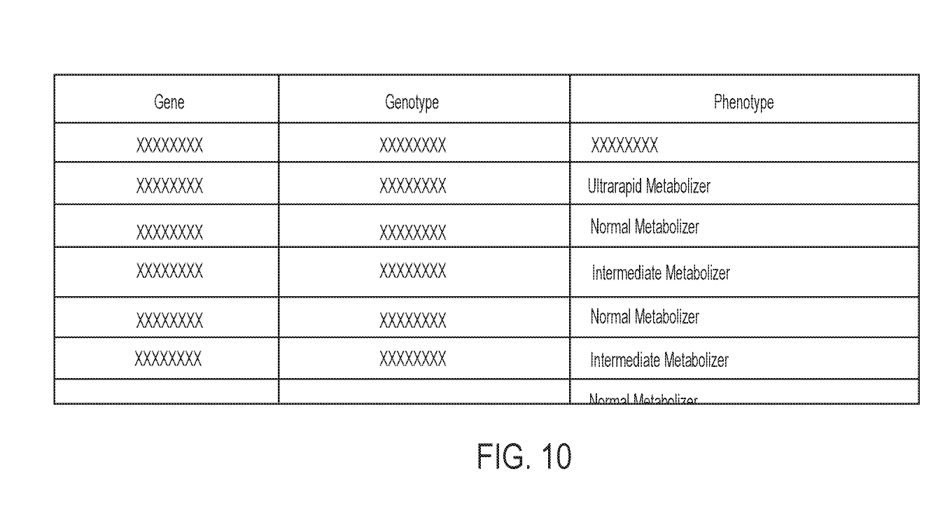

FIG. 10 shows another example report that may be presented, for example, via a graphical user interface on a display device in one embodiment of the present disclosure. The sample report shows genotype and phenotype results for a patient. For example, gene, genotype and phenotype associated with the patient may be shown in a tabular format.

Other reports may show detected genes and variants.

The methodology of the present disclosure in one embodiment may apply to different fields of medicine such as oncology, neurology, and others.

In one aspect, the functionalities and modules of the system and methods of the present disclosure may be implemented or carried out distributed on different processing systems or on any single platform, for instance, accessing data stored locally or distributed on the network.

Various aspects of the present disclosure may be embodied as a program, software, or computer instructions embodied or stored in a computer or machine usable, readable or executable medium, which causes the computer or machine to perform the steps of the method when executed on the computer, processor, and/or machine. For instance, a program storage device or storage medium readable by a machine, tangibly embodying a program of instructions executable by the machine to perform various functionalities and methods described in the present disclosure may be provided. A program storage device or computer readable storage medium may include, but are not limited to, devices such as a hard disk, a random access memory (RAM), a read-only memory (ROM), an erasable programmable read-only memory (EPROM), flash memory, a static random access memory (SRAM), a portable compact disc read-only memory (CD-ROM), a digital versatile disk (DVD), a removable flash memory card, a floppy disk, and other devices that can store computer executable instructions and readable by a machine. Such program storage device or computer readable storage medium excludes transitory signals per se. A computer program product may include such program storage device or computer readable storage medium.

The system and method of the present disclosure may be implemented and run on a general-purpose computer or special-purpose computer system. The computer system may be any type of known or will be known systems and may include a hardware processor, memory device, a storage device, input/output devices, internal buses, and/or a communications interface for communicating with other computer systems in conjunction with communication hardware and software, etc.

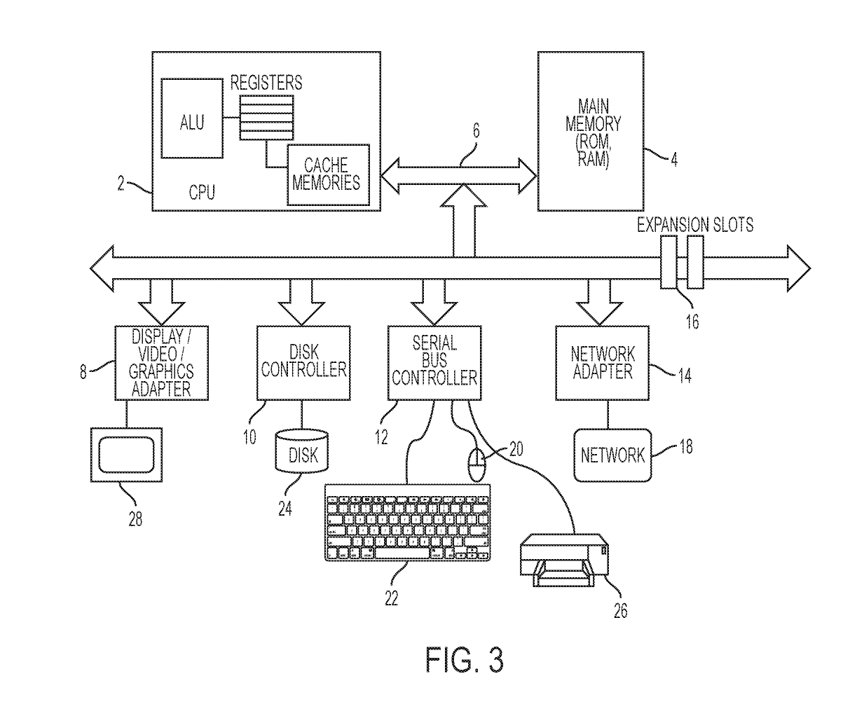

FIG. 3 illustrates an example computer system that may implement the system and/or method of the present disclosure. One or more central processing units (e.g., CPUs) 2 may include one or more arithmetic/logic unit (ALU), fast cache memory and registers and/or register file. Registers are small storage devices; register file may be a set of multiple registers. Caches are fast storage memory devices, for example, comprising static random access (SRAM) chips. Caches serve as temporary staging area to hold data that the CPU 2 uses. Shown is a simplified hardware configuration. CPU 2 may include other combination circuits and storage devices. One or more central processing units (CPUs) 2 execute instructions stored in memory 4, for example, transferred to registers in the CPU 2. Buses 6, for example, are electrical wires that carry bits of data between the components. Memory 4 may include an array of dynamic random access memory (DRAM) chips, and store program and data that CPU 2 uses in execution. The system components may also include input/output (I/O) controllers and adapters connected to the CPU 2 and memory 4 via a bus, e.g., I/O bus and connect to I/O devices. For example, display/graphic adapter connects 8 a monitor 28 or another display device/terminal; disk controller 10 connects hard disks 24, for example, for permanent storage; serial controller 12 such as universal serial bus (USB) controller may connect input devices such as keyboard 22 and mouse 20, output devices such as printers 26; network adapter 14 connects the system to another network, for example, to other machines. The system may also include expansion slots to accommodate other devices to connect to the system. For example, a hard disk 24 may store the program of instructions and data that implement the above described methods and systems, which may be loaded into the memory 4, then into the CPU's storage (e.g., caches and registers) for execution by the CPU (e.g., ALU and/or other combination circuit or logic). In another aspect, all or some of the program of instructions and data implementing the above described methods and systems may be accessed, and or executed over the network 18 at another computer system or device. FIG. 3 is only one example of a computer system. The computer system that may implement the methodologies or system of the present disclosure is not limited to the configuration shown in FIG. 3. Rather, another computer system may implement the methodologies of the present disclosure, for example, including but not limited to special processors such as field programmable gate array (FPGA) and accelerators.

The terms “computer system” and “computer network” as may be used in the present application may include a variety of combinations of fixed and/or portable computer hardware, software, peripherals, mobile, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer-implemented method comprising:
receiving sample data entered into a laboratory information system;
performing de-identification of the sample data and generating a unique identifier (ID) per sample;
producing next generation sequencing data per sample;
generating, by a computer server, variants and coverage data associated with the sample having the unique ID;
performing, by the computer server, genotype, phenotype data analysis based on the variants and coverage data;
providing, by the computer server, clinical interpretation for drug usage and dosing recommendation associated with the unique ID; and
generating, by the computer server, a report based on the clinical interpretation for drug usage and dosing recommendation associated with the unique ID.

2. The method of claim 1, further comprising:
performing sample accessioning to verify that the sample data match sample information received at a laboratory before said performing of the de-identification.

3. The method of claim 1, wherein the providing clinical interpretation for drug usage and dosing recommendation associated with the unique ID comprises:
generating a drug recommendation covering multiple therapeutic areas based on the genotype; or
generating a customized diagnostic specific drug recommendation based on the genotype and ICD codes; or
combinations thereof.

4. The method of claim 1, wherein the report comprises:
comprehensive and customized diagnostic specific drug recommendations associated with the unique ID;
current drug recommendations associated with the unique ID; or
drug, food, alcohol interactions associated with the unique ID; or
combinations thereof.

5. The method of claim 1, further comprising:
identifying a patient using the unique ID.

6. A computer readable storage medium storing a program of instructions executable by a machine to perform a method comprising:
receiving sample data entered into a laboratory information system;
performing de-identification of the sample data and generating a unique identifier (ID) per sample;
producing next generation sequencing data per sample;
generating variants and coverage data associated with the sample having the unique ID;
performing genotype, phenotype data analysis based on the variants and coverage data;
providing clinical interpretation for drug usage and dosing recommendation associated with the unique ID; and
generating a report based on the clinical interpretation for drug usage and dosing recommendation associated with the unique ID.

7. The computer readable storage medium of claim 6, further comprising:
performing sample accessioning to verify that the sample data match sample information received at a laboratory before said performing of the de-identification.

8. The computer readable storage medium of claim 6, wherein the providing clinical interpretation for drug usage and dosing recommendation associated with the unique ID comprises:
generating a drug recommendation covering multiple therapeutic areas based on the genotype; or
generating a customized diagnostic specific drug recommendation based on the genotype and ICD-9 code; or
combinations thereof.

9. The computer readable storage medium of claim 6, wherein the report comprises:
a comprehensive and customized diagnostic specific drug recommendation associated with the unique ID.

10. The computer readable storage medium of claim 6, wherein the report comprises:
drug, food, alcohol interactions associated with the unique ID.

11. A system comprising:
one or more hardware processors;
a laboratory information system operable to receive sample data and perform de-identification of the sample data and generating a unique identifier (ID) per sample;
a computer server comprising bioinformatics data analysis pipeline operable to generate variants and coverage data associated with the sample data having the unique ID, the computer server operable to execute on one or more of the hardware processors;
the computer server comprising the bioinformatics data analysis pipeline further operable to perform genotype, phenotype data analysis based on the variants and coverage data and provide clinical interpretation for drug usage and dosing recommendation associated with the unique ID; and
a report generation module operable to execute on one or more of the hardware processors and further operable to generate a report based on the clinical interpretation for drug usage and dosing recommendation associated with the unique ID.

12. The system of claim 10, wherein the computer server is operable to receive raw sequencing data associated with the de-identified sample having the unique ID, and further operable to perform variant calling, coverage analysis based on sequencing data to provide the clinical interpretation for drug usage and dosing recommendation associated with the unique ID.

13. The system of claim 10, wherein the report comprises a drug recommendation covering multiple therapeutic areas based on the genotype.

14. The system of claim 10, wherein the report comprises a customized diagnostic specific drug recommendation based on the genotype and ICD-9 code.

15. The system of claim 10, wherein the report comprises a comprehensive and customized diagnostic specific drug recommendation associated with the unique ID.

16. The system of claim 10, wherein the report comprises drug, food, alcohol interactions associated with the unique ID.
